(19) United States
(12) Patent Application Publication
(10) Pub. No.: US 2014/0278557 A1
(43) Pub. Date: Sep. 18, 2014

(54) COMPLEX INFORMATION MANAGEMENT SYSTEM AND METHOD

(71) Applicant: Jassem Shahrani, Austin, TX (US)

(72) Inventor: Jassem Shahrani, Austin, TX (US)

(21) Appl. No.: 14/218,899

(22) Filed: Mar. 18, 2014

Related U.S. Application Data
(60) Provisional application No. 61/801,527, filed on Mar. 15, 2013.

(51) Int. Cl. G06F 19/00; G06F 17/30; G06F 3/0482; H04L 12/24

(52) U.S. Cl. CPC G06F 19/322; H04L 41/22; G06F 17/30289; G06F 3/0482
USPC 705/3; 715/739; 707/756

(57) ABSTRACT

A method for maintaining a system of complex information comprises extracting, from an existing system of complex information, a structure and a plurality of associations. The extracting preserves the structure and plurality of associations. The extracted data is converted to a first intermediate format. The converted data is imported into a first custom database. Information stored in the existing system of complex information data is displayed to a user based on at least the structure and plurality of associations.

### RELATED APPLICATIONS

This application claims priority to provisional application 61/801,527, filed 15 Mar. 2013, titled “Complex Information Management System and Method,” and incorporated in its entirety herein.

### TECHNICAL FIELD

The present invention relates generally to the field of information management and, more particularly, to a complex information management system and method.

### BACKGROUND

Modern research and innovation has led to a proliferation of information available to practitioners in a wide variety of fields. But as the volume of information increases, and governmental regulatory burdens multiply, identifying and processing relevant information has become problematic. As such, systems have been developed to organize and share information among practitioners across several platforms. The wide variety in approach and structure of these systems has given rise to additional challenges in applying the wisdom accumulated in research and innovation to practice in the field.

One approach to managing performance in light of developing information is embodied in the concept of “evidence-based” practice. For example, “evidence-based medicine” has become a popular approach for medical practitioners endeavoring to treat patients with the best available courses of treatment as soon as appropriate. Generally, evidence-based medicine seeks to associate the most recent advances in the art with the best practices actually employed by the practitioners treating patients. As such, evidence-based medicine is a complex process, raising new challenges in managing and organizing large amounts of frequently-changing data.

Additionally, advances in information technology have given rise to new techniques to improve and simplify processing the information contained in such large amounts of frequently-changing data. One such advance in the medical information technology field has been the increasing use of “electronic health records” (EHRs). Generally, EHRs are sophisticated data structures, typically supported by highly-customized access and management systems and protocols.

While advances in managing data have continued, advances in accumulating and synthesizing research have also developed. For example, in the medical field, business entities called “evidence vendors” have arisen that do much of the difficult work of identifying, processing, and synthesizing the new information provided in research journals, clinical trials, and a wide variety of other sources.

Similarly, a wide variety of custom tools have been developed to apply pre-processed evidence to existing or proposed practices for use in the field. However, the existing custom tools require a significant time investment in data management, some of which requires expertise in the field and some of which only requires basic skills in database management. Present tools fail to provide simple information management capabilities that can be allocated to the most appropriate skill-level in an organization employing the information in daily practice.

### BRIEF SUMMARY

The following summary is provided to facilitate an understanding of some of the innovative features unique to the embodiments disclosed and is not intended to be a full description. A full appreciation of the various aspects of the embodiments can be gained by taking into consideration the entire specification, claims, drawings, and abstract as a whole.

In one aspect of the present invention, a user interface is provided for presenting associated data to a user. The user interface comprises a user input device configured to receive user input and a display having a screen configured to present an information framework to a user. The information framework comprises a first area and a second area. Each of the first and second areas present a view associated with a collection of data. The first and second areas do not overlap with each other. The data comprises content, evidence, and associations linking evidence and content. The content comprises a plurality of operational material items and the evidence comprises a plurality of support material items. The first area is configured to present options for selection by a user and an input box to receive a search query from the user. The search query and user-selected option together comprise a user request. The information framework couples to a server, the server being configured to process user requests. The second area is configured to receive server responses to the user requests and to display received server responses to the user in at least the second area. The server response comprises indicia uniquely identifying an item of operational material or an item of evidence, and indicia identifying an association between the uniquely identified item and at least one other item of operational material or item of evidence. And the second area is configured to display the uniquely identified item and at least one other item of operational material or item of evidence associated with the uniquely identified item.

In one embodiment of the user interface the collection data is electronic health record data.

In one embodiment of the user interface, options presented for selection by a user of the first area include at least one item of supplemental data. The server response includes an identified content item, the identified content item being selected by the server based on the received item of supplemental data. The first area is configured to display the identified content item. The server response further includes an evidence association, the evidence association comprising at least one item of evidence associated with the identified content item. The second area is configured to display the at least one item of evidence associated with the identified order set. And the second area is further configured to display supplemental data associated with the at least one item of evidence associated with the identified order set.

In one embodiment of the user interface, the content includes at least one clinical content record or artifact. The input box of the first area is configured to receive a title search string representing a desired clinical content record or artifact. The server response includes an identified clinical content record or artifact, the identified clinical content record or artifact being selected by the server based on the received title search string. The first area is configured to display the identified clinical content record or artifact and associated utilization data. The server response further includes an evidence association, the evidence association comprising at least one item of evidence associated with the identified clinical content record or artifact. The second area is configured to display the at least one item of evidence associated with the identified clinical content record or artifact. And the second area is further configured to display supplemental data associated with the at least one item of evidence associated with the identified clinical content record or artifact.

In one embodiment of the user interface, the views presented in the first and second areas are different. In another embodiment of the user interface, the first and second areas are one of horizontal bands and quadrants.

In another aspect of the present invention, a method for maintaining an electronic health records (EHR) information system is provided, the method comprising extracting EHR data from an operational EHR system, the operational EHR system having a structure and a plurality of associations. The extracted EHR data preserves the structure and plurality of associations. Extracted EHR data is converted to a first intermediate format. Converted EHR data is imported into a first custom database. And information stored in the EHR data is displayed to a user based on at least the structure and plurality of associations.

In one embodiment, the method further comprises detecting a change in the structure or one of the plurality of associations in the EHR data based on a previously saved version of the imported EHR data and displaying the difference between the current version and the saved version to a user.

In one embodiment, the method further comprises extracting evidence data from a vendor-source. The extracted evidence is converted to a second intermediate format. The intermediate format evidence data is imported into a second custom database. And the imported EHR data is associated with imported evidence data. In one embodiment, extracting EHR data further comprises preserving the structure and plurality of associations at all levels of granularity.

In another aspect of the present invention, a method for maintaining a system of complex information includes extracting, from an existing system of complex information, a structure and a plurality of associations. The extracting preserves the structure and plurality of associations. The extracted data is converted to a first intermediate format. The converted data is imported into a first custom database. And information stored in the existing system of complex information data is displayed to a user based on at least the structure and plurality of associations.

### BRIEF DESCRIPTION OF THE DRAWINGS

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 is a block diagram showing a Complex Information Management System in accordance with one embodiment;

FIG. 2 is a block diagram showing a Complex Information Management System in accordance with one embodiment;

FIG. 3 is a block diagram showing part of a Complex Information Management System in accordance with one embodiment;

FIG. 4 is a flow diagram showing a Complex Information Management Method in accordance with one embodiment;

FIGS. 5 and 6 are block diagrams illustrating an graphical user interface of a Complex Information Management System in accordance with one embodiment; and

FIG. 7 onward are example implementations in accordance with one embodiment, with a particular characterization of the state of the art.

FIG. 7 illustrates an example user interface for content management in accordance with one embodiment.

FIG. 8 illustrates an example user interface dashboard in accordance with one embodiment.

FIG. 9 illustrates features helping to find, filter, and discover relevant evidence in accordance with one embodiment.

FIG. 10 illustrates managing associations and changes in accordance with one embodiment.

FIG. 11A illustrates content associated with specified data in accordance with one embodiment.

FIG. 11B illustrates content affected by a data update in accordance with one embodiment.

FIG. 12 illustrates content interaction data management in accordance with one embodiment.

FIG. 13 illustrates content utilization dashboards in accordance with one embodiment.

FIG. 14 illustrates content version refreshing in accordance with one embodiment.

FIG. 15 illustrates cross-organization sharing in accordance with one embodiment.

FIG. 16 illustrates EHR evidence link management in accordance with one embodiment.

FIG. 17 illustrates evidence penetration dashboards in accordance with one embodiment.

FIG. 18A illustrates import of evidence alignment in accordance with current practices.

FIG. 18B illustrates import of evidence alignment in accordance with one embodiment.

FIG. 19A illustrates initial and update builds of content in accordance with current practices.

FIG. 19B illustrates initial and update builds of content in accordance with one embodiment.

FIG. 20 illustrates metadata use and management in accordance with one embodiment.

### DETAILED DESCRIPTION

The particular values and configurations discussed in these non-limiting examples can be varied and are cited merely to illustrate at least one embodiment and are not intended to limit the scope of the invention.

In the following discussion, numerous specific details are set forth to provide a thorough understanding of the present invention. Those skilled in the art will appreciate that the present invention may be practiced without such specific details. In other instances, well-known elements have been illustrated in schematic or block diagram form in order not to obscure the present invention in unnecessary detail. Additionally, for the most part, details concerning network communications, electro-magnetic signaling techniques, user interface or input/output techniques, and the like, have been omitted inasmuch as such details are not considered necessary to obtain a complete understanding of the present invention, and are considered to be within the understanding of persons of ordinary skill in the relevant art.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

FIG. 1 illustrates a system 100 for Complex Information Management in accordance with one embodiment. For ease of discussion, the embodiments disclosed herein will be discussed with respect to a complex information management in the medical field. Specifically, the embodiments disclosed herein will be discussed with respect to managing an “electronic health record” (EHR) system.

One skilled in the art will appreciate that the embodiments disclosed herein can be adapted to manage complex information in other fields. For example, in one embodiment, the embodiments disclosed herein can be adapted to manage contract and licensing information, debt collection process information, regulatory information, and other information. As such, the scope of the invention should be limited only by the claims.

Referring to FIG. 1, system 100 includes a complex information management server 110 “EviCloud”™. As described in more detail below, in one embodiment, server 110 is configured to interact with various components of system 100 to organize, manage, and update a wide variety of information and data. As used herein, EviCloud refers to one or more products of the EviCloud brand.

Generally, one skilled in the art will understand that healthcare organizations frequently require a process to manage and maintain “content” that exists in EHRs. In one embodiment, “content” includes, but is not limited to, clinical content records, content artifacts, and clinical decision support information, such as order sets, care plans. In many cases, management and maintenance of this content includes clinical evidence associations to this content, clinical performance measure associations to this content, versioning of this content, metadata about this content (for example, users designated as owners and/or reviewers of the content), collaboration regarding this content, and other interaction with the content.

As described in more detail below, the disclosed embodiments can be configured to enable healthcare organizations to automatically extract EHR content to a system that can then be used to store associations of the extracted content with applicable evidence. In one embodiment, the extracted EHR content preserves the exact structure and all references to the most granular level. In one embodiment, when evidence changes, the associations can be leveraged to identify which content to review. If deemed appropriate, the healthcare organizations will manually update the actual EHR content to reflect the latest evidence. Finally, in one embodiment, the healthcare providers can refresh the copied content from the EHR automatically while the system maintains a history of changes to both the copied content and the evidence.

In one embodiment, server 110 is configured to gather, maintain, and manage clinical content from EHRs, evidence vendors, and other sources of data, which makes exploration, analysis, and processes more efficient and often automatic. In one embodiment, server 110 extracts and subsequently imports EHR data, EHR utilization data, clinical evidentiary data, and other data in order to provide an interface for designing and maintaining the structure, integrity, utility of, and relationships between, those data. In one embodiment, server 110 can be configured to automatically build and store important associations between those data. In one embodiment, system 110 is configured to employ those data associations to drive interfaces for quickly searching, finding, filtering, and changing associations between those data, automatic change and impact analysis/insight, and interfaces for analyzing those data to provide insight into the associations and the impact of those associations on business processes, reimbursement opportunities, government and institutional incentives, and clinical outcomes related to, but not limited to, cost-saving, patient length of stay, admissions, readmissions, and mortality. In one embodiment, system 110 is configured to provide an interface for user-defined metrics that can create and manage new associations not ordinarily considered or otherwise commonly available in the EHR context.

In one embodiment, server 110 is configured to extract EHR content artifacts and corresponding utilization data. This data is represented in the exact EHR structure on the web in an extensible form, enabling more efficient management and maintenance of this EHR content.

In one embodiment, server 110 includes a web interface configured to manage clinical content and evidence queries, manage evidence-content associations, creation and enablement of source of truth collaboration and downtime form creation, and functional display of content utilization metrics.

In one embodiment, system 100 is configured for automation of evidence change impact based on content-evidence associations. In one embodiment, the content-evidence associations have been previously extracted, in their native format, from an operational EHR system.

In one embodiment, system 100 includes one or more user interfaces (e.g., 132, 134) configured to display information to, and receive information from, a user.

In one embodiment, the user interface is configured to display the related evidence for a group/section, even when it is not associated with that particular node. In one embodiment, the user interface includes a “find related evidence” button. In one embodiment, the “find related evidence” button is displayed as greyed out on the non-current node and not grayed out on the current/associated node. Thus, in one embodiment, system 100 can be configured to show all of the evidence associated with an order set, or other content, even if the currently selected node isn't the specifically associated node.

In one embodiment, the user interface provides a number of technical advantages, including, but not limited to:

### Ability to Find, Filter, Discover Relevant Evidence

### Ability to Find, Filter, Discover Content Artifacts

### Ability to Manage Evidence Associations

### Content Version Management

### Automated Evidence Change Notification

Single Hyperlink Management of Content Evidence with EviCloud (e.g., server 110) as Evidence Source of Truth

### Metadata Management and Export/Import of Metadata to EHR

1-Click creation of GoogleDocs supported Collaboration and EHR Downtime Forms

### Cross-Organizational Content Sharing

### Evidence Penetration Dashboard

### Content Artifact Utilization Dashboard

Additionally, in one embodiment, the user interface can be configured to emphasize data presentation in a way that improves the user experience. For example, in one embodiment, server 110 can be configured with a multidimensional filter over artifacts and recommendations. Typical prior solutions only enable mutually exclusive queries.

In one embodiment, Data dimensions include, but are not limited to, content name/title, times used, # resulting orders, type of order (medication, procedure, inpatient, etc.), physician name, physician-specific usage (content usage and orders resulting from content).

Current Vendor Toolsets fail to maintain the native EHR content artifact structures and relationships. In one embodiment, EviCloud has the complete structures and relationships, and represents them in an extensible data architecture.

In one embodiment, EviCloud stores data in a way that allows for arbitrary-hierarchical structured JSON to define a given piece of clinical content, while allowing for content associations to be added/removed/maintained at any level in that hierarchy. It does this by storing the content in a custom JSON format which preserves the hierarchy as well as unique keys to data within the underlying structure. In one embodiment, the data associations to clinical content are stored by keeping track of the following (in part):
unique EviCloud id of content
specific native/legacy id of node where data is to be associated
specific native/legacy type of node where data is to be associated
unique EviCloud id of data to associate (example: clinical evidence)

Previous attempts to solve this problem involve authoring and maintaining a set of clinical content in a 3rd party system, which must also be separately authored and maintained in the EHR (or the EHR must provide a direct integration mechanism—many do not—and this integration approach is difficult in itself to maintain as any changes to either system can break the integration). In one embodiment, EviCloud extracts and brings in the EHR content in its native structure, with the purpose of maintaining data associations which are difficult to maintain directly in the EHR, as well as computing and providing interfaces to analytics over that data and the associations. One crucial difference is that because EviCloud extracts and always operates on the EHR native data, the need to double-maintain the state and structure of the EHR data is removed. On top of that, because EviCloud brings in that native EHR data, EviCloud inherently has access to more of the data—and metadata—which can serve as valuable input to computations and aggregations performed by EviCloud.

The state of the art of evidence-based clinical content management attempts to either manually replicate complete EHR content (or a shell) outside of the EHR for collaboration or requires end users to access the EHR directly to collaborate indirectly.

In one embodiment, EviCloud is novel in its simplified approach to the evidence-based clinical content management problem. Specifically, EviCloud automatically renders complete EHR content identical to the source, which allows for direct collaboration with no overhead or intermediate layers.

In one embodiment, server 110 includes a variety of applications and modules. In one embodiment, server 110 includes:
application to extract data from an EHR into custom format
application to import extracted data into custom database
application to build associations between data
application to provide an interface to that data which
   a allows a user to view, add, and change associations between the data
   b allows the user to search and filter data based on associations between the data, and contents of the data
application to provide an interface to view aggregate data counts, statistics, and associations
application to format data and inject data into a system for collaboration, while preserving and representing data hierarchy, relationships, and associations
application to maintain versions of data and data associations
application for ingestion of content into intermediate format, ingestion of evidence, ingestion of utilization metrics, associate evidence to content, see evidence/content association versions, collaborate on source of truth, generate downtime forms based on source of truth, enable sharing of source of truth content across multiple health care organizations for multi-system review, collaboration, evidence design

In one embodiment,
ingestion of content enables content tagging, querying, fast association, source of truth manipulation
ingestion of evidence enables evidence tagging, querying, fast association, analysis for change control
ingestion of utilization metrics enables content adoption analysis
evidence associations enables tracking of what is built into an EMR database and associated to content, and also enables automation of impact to content when evidence changes, and also enables analytic view of evidence not associated to content.
version management enables review of medicolegal state in time
Source of truth ingestion to intermediate formal enables collaboration and downtime form generation

One example embodiment includes some or all of the following:
1) run content extraction script and generate content in preferred form
2) import content into EviCloud
3) obtain extract of evidence from Evidence Vendor in preferred form
4) import evidence into EviCloud
5) run data extraction script for content utilization in preferred form
6) import utilization data into EviCloud
7) user login to EviCloud and select EviContent
8) user manipulate content filters to attain desired content subset or record
9) user manipulate evidence filters to attain desired evidence subset or record
10) user select “associate” on evidence record to associate evidence to content record
11) user select “in ehr” to indicate evidence is “built” into the ehr according to user definition
12) user select “unassociate” to unassociate evidence record from content record
13) user select “in ehr” to indicate evidence record is no longer “built” into ehr according to user definition
14) user select “collaborate” on content record to generate Google Document in User/Enterprise Instance of Google Documents
15) user select “downtime” to generate Google Document in User/Enterprise Instance of Google Documents
16) user select “EviDashboard” to navigate to new user interface to review dahsboard analytic data
17) user select individual metric on evidence dashboard to review segments of evidence correlations to content
18) user select “Adoption Dashboard” to review content utilization metrics by content record and by clinician user
19) in EviContent user select “Version Management”, user select from available import dates to open EviContent in view only mode with previous version of Content and Evidence with associations intact as of previous import
20) in EviContent user select “Version Management”, user select “most recent loads” to open the current edit-mode EviContent view
21) admin user selects “Administration”, admin user selects “share content with other organizations” admin user selects unique organizations with which to share entire library of content.
22) if reciprical sharing is selected by organizations, users will see “Other Organizations' Content” option in EviContent
23) user selects “Other Organizations' Content” and can select specific organization name
24) user selecting name of other organization opens view only instance of EviContent showing other organizations' conten
user can complete documentation of metadata about content (review dates, owners, etc) and this data can be exported into an epic friendly import format by selecting “export” on the metadata UI

In one embodiment, server 110 includes at least:
application to extract data from an EHR into custom JSON format
application to import extracted data into custom database
application to build associations between data
application to provide an interface to that data which
application to provide an interface to view aggregate data counts, statistics, and associations
application to format data and inject data into a system for collaboration, while preserving and representing data hierarchy, relationships, and associations
application to maintain versions of data and data associations

Technical Advantages of some embodiments include:
improved algorithm and format of data
the structure and purpose of the extracted provides advantages
applying the formatting and structure of custom databases together on EHR data for the intended purpose provides advantages
advantages include providing a single-click, real-time data search and filter ability based on customized/built data associations
real-time, current snap-shot of important computations, and the ability to dynamically refine, filter, sort, etc. that data based on important dimensions of consideration
enables collaboration on EHR data where:
   a the collaboration is achieved with a single click
   b the collaboration document is automatically generated
   c all native and new structure and data associations are maintained
   d the collaboration can be performed in real-time, simultaneously by multiple users

In one embodiment, import of data and associations can be configured as step 2 of a two-step load process, where initially only the Content Objects (or portions necessary for display) are fetched, and the data associations are fetched on the fly when a user takes an action which should show that data/those associations. In one embodiment, server 110 can be configured to automatically and immediately identify which content (the native EHR content) is impacted by changed data to which that content is associated. Current art cannot identify these changes in the native EHR content.

In one embodiment, “Content”=Clinical Content=Order Sets=Plans of Care=Rules=Alerts=Documentation Templates.

In one embodiment, operational material is data, instructions, (order sets), policies, or otherwise active items collected together where some action is taken or ordered, such as, for example based on the current status of an environment of interest. In one embodiment, operational material is order sets, etc.

In one embodiment, support material is data, presentations, research results, or otherwise passive items collected together to provide justification for one or more operational material items, such as, for example based on the current understanding of how the environment of interest responds to inputs. In one embodiment, support material is EHR “evidence” (as that term is used in the art), journal articles, etc.

In the illustrated embodiment, server 110 couples to evidence vendor systems 124, other sources 126, a user interface 132, an admin/collaboration module 130, and an EHR system 120. In the illustrated embodiment, user interface 132 is configured for use by a user technician 122. In the illustrated embodiment, admin/collaboration module 130 is configured for use by a user admin 122.

In the illustrated embodiment, EHR system 120 couples to a filler system 122 and a user interface 134. In the illustrated embodiment, user interface 134 is configured for use by a user clinician 122.

In one embodiment, filler system 122 represents the point of care for a user patient 122, such as a pharmacy, physician, therapist, etc.

The following information describes an example embodiment(s) in additional detail. These figures contain the information presented in provisional application 61/801,527, filed 15 Mar. 2013, titled “Complex Information Management System and Method,” and incorporated in its entirety herein.

FIG. 2 is a block diagram showing a Complex Information Management System in accordance with one embodiment. In the illustrated embodiment, FIG. 2 includes a system 200. In one embodiment, system 200 is the server 110 of FIG. 1.

In the illustrated embodiment, system 200 includes a user interface 210, an admin module 212, an evidence database 220, a content database 222, an associations database 224, a versioning database 226, an import module 230, an extraction module 240, and a collaboration module 250. Various features are described herein.

FIG. 3 is a block diagram showing part of a Complex Information Management System in accordance with one embodiment. In the illustrated embodiment, FIG. 3 includes a system 300. In one embodiment, system 300 includes various components as illustrated in FIGS. 1 and 2.

In the illustrated embodiment, system 300 includes an EviCloud server 302, an evidence library (database) 310, and an import module 320. Generally, import module 320 couples to one or more evidence servers 350, each provided by a vendor VA, VB . . . VN. In the illustrated embodiment, import module 320 includes vocabulary module 322, format module 324, associations to content module 326, and mapping module 340. In the illustrated embodiment, mapping module includes evidence IDs 342 and content IDs 344.

In the illustrated embodiment, evidence library (database) 310 include an evidence artifact 312. In the illustrated embodiment, evidence artifact 312 includes metadata 314.

FIG. 4 is a flow diagram 400 showing a Complex Information Management Method in accordance with one embodiment. In one embodiment, an operational flow diagram includes the following steps.

As shown at block 405, the process begins and “Extract EHR Data from Operational EHR System” is performed. In one embodiment, this extraction assigns EviCloud IDs to content/nodes/artifacts and maintains current associations and hierarchy.

As shown at block 410, the process performs “Extract Evidence Data from Vendor-Specific Source.” In one embodiment, vendor-specific source includes both their toolset and a version that the vendors provide that is supposed to be able to import into a localization tool. In one embodiment, this maintains vendor-provided associations, hierarchy, and recommendations.

As shown at block 415, the process performs “Extract Other Data.” As shown at block 420, the process performs “Convert Extracted EHR Data to Intermediate Format.” As shown at block 425, the process performs “Import Intermediate Format EHR Data into First Custom Database.”

As shown at block 430, the process performs “Convert Extracted Evidence Data to Intermediate Format.” In one embodiment, this conversion includes reformatting to a vendor-neutral format, assigns EviCloud IDs to evidence/artifacts, updates vocabulary to a generic or customer-specific vocabulary, and manages duplicative evidence (e.g., “aspirin, 35 mg” is the same even if vendors have different terminology for it (e.g., “aspirin, plain, 35 mg”)).

As shown at block 435, the process performs “Import Intermediate Format Evidence Data into Second Custom Database.” As shown at block 440, the process performs “Associate Imported EHR Data with Imported Evidence Data.” As shown at block 445, the process performs “Create Versioning Backup on Versioning Server.” As shown at block 450, the process performs “Refresh EHR Data on Operational Server.”

These process steps are described in further detail herein.

In one embodiment, the first, second custom databases and the versioning server can all be the same database/server.

FIGS. 5 and 6 are block diagrams illustrating a graphical user interface (GUI) of a Complex Information Management System in accordance with one embodiment. FIG. 5 illustrates GUI 500. In the illustrated embodiment, GUI 500 is an “EviContent” GUI.

In the illustrated embodiment, GUI 500 includes content query pane 502. Content querying is multidimensional (e.g., query by content location and venue and title.) Search results are dynamically responsive.

In the illustrated embodiment, GUI 500 includes a content display pane 504. Content extracted from the EHR maintaining structure. Content displayed is dynamic according to query. Content can be 1-click rendered in Google Docs for collaboration or EHR downtime needs. Content details can be explored via a tree structure.

In the illustrated embodiment, GUI 500 includes evidence query pane 510. Evidence query is multidimensional. Search results are dynamically responsive. In the illustrated embodiment, GUI 500 includes search results pane 512.

In the illustrated embodiment, GUI 500 includes content artifact evidence associations pane 520. Upon selecting a content record, evidence that has been associated to the record will display. Users can take several actions on the evidence (such as opening the vendor evidence page, documenting the evidence as built in the EHR, or un-associating the evidence, etc.). In the illustrated embodiment, GUI 500 includes metadata pane 522. Metadata can be edited, exported, and imported into the EHR.

FIG. 6 illustrates GUI 600. In the illustrated embodiment, GUI 600 is an “EviDashboard” GUI. In the illustrated embodiment, GUI 600 includes Specific Evidence Data Breakdown (Associations to Content) pane 602. Evidence alignment is illustrated with a focus on Cost, Length of Stay, Mortality, and Re-admissions.

In the illustrated embodiment, GUI 600 includes a Specific Evidence Data Breakdown (Associations to Content) pane 604. Evidence alignment is illustrated with a focus on CMS performance measures.

In the illustrated embodiment, GUI 600 includes Specific Order Set Utilization Data by TITLE pane 606. Order set utilization can be reviewed with a dynamic title search and several other vectors including resulting orders from order sets used.

In the illustrated embodiment, GUI 600 includes Specific Order Set Utilization Data by PHYSICIAN pane 608. Order set utilization can be reviewed by provider who used the order set.

FIG. 7 onward are example implementations in accordance with one embodiment, with a particular characterization of the state of the art. FIG. 7 illustrates an example user interface for content management in accordance with one embodiment. Specifically, FIG. 7 illustrates an EviContent view, such as described with respect to FIG. 5, above. Additionally, FIG. 8 illustrates an EviDashboard view, such as described with respect to FIG. 6, above.

FIG. 9 illustrates features helping to find, filter, and discover relevant evidence in accordance with one embodiment. As shown in FIG. 9, the current process requires the steps of: (905) Evidence vendor creates or synthesizes evidence; (910) Evidence vendor makes evidence available in their toolset, aligned with their vendor content, in addition to making evidence available by spreadsheet or online review; and (915) Customer searches for evidence in spreadsheet or online toolset.

By contrast, the EviCloud process involves the single step of (950) Evidence extract(s) provided by customer is/are imported into EviCloud. Evidence is available and filterable by several vectors. Note on Filter Distinction: EviCloud has a multidimensional filter over artifacts and recommendations. Current state solutions only enable mutually exclusive queries.

FIG. 10 illustrates managing associations and changes in accordance with one embodiment. As shown in FIG. 10, the current process requires the steps of: (1005) Customer provides access to manually rebuilt content in vendor toolset to vendor, or provides paper copies of content to vendor; (1010) Vendor or customer manually assesses content to determine evidence changes; (1015) Vendor or customer determine if new evidence should be added to EHR; (1020) Customer builds associations and changes to evidence into the EHR environment; and (1025) Customer builds associations and changes into the vendor environment if double maintaining content for the next iteration. The current art process returns to step 1005. Vendors today do not track EHR content and evidence associations. They may track EHR content that is rebuilt into the vendor system with evidence. (Vendor is not an accurate source of truth.)

By contrast, the EviCloud process involves the following steps: (1050) Customer loads evidence version into EviCloud; (1055) Evicloud automatically identifies content affected by any evidence changes; (1060) Vendor, customer, or consultant adds/updates/removes content-evidence associations in EviCloud; and (1065) Customer can associate new evidence to content in EviCloud. The EviCloud process returns to step 1050.

Thus, the customer no longer has to doubly maintain content structure and content-evidence associations. Both evidence and content come into EviCloud by simple import instead of manually building it into toolsets. (Assume Evidence and Content have existing relationships in the EHR.)

FIG. 11A illustrates content associated with specified data in accordance with one embodiment.

FIG. 11B illustrates content affected by a data update in accordance with one embodiment. In the illustrated embodiment, the far right side may be step two of a two-step load process, where initially only the Content Objects (or portions necessary for display) are fetched, and the data associations are fetched on the fly when a user takes an action that should show that data/those associations.

As shown in FIG. 11B, in one embodiment, the system is configured to have the ability to automatically and immediately identify which content (the native EHR content) is impacted by changed data to which that content is associated. Current art cannot identify these changes in the native EHR content.

FIG. 12 illustrates content interaction data management in accordance with one embodiment.

FIG. 13 illustrates content utilization dashboards in accordance with one embodiment.

FIG. 14 illustrates content version refreshing in accordance with one embodiment.

FIG. 15 illustrates cross-organization sharing in accordance with one embodiment.

FIG. 16 illustrates EHR evidence link management in accordance with one embodiment.

FIG. 17 illustrates evidence penetration dashboards in accordance with one embodiment.

As shown in FIG. 17, in one embodiment, the evidence penetration interfaces show metrics including, but not limited to:
# evidence artifacts associated with a given performance measure (PM) or patient-related outcome (PRO)
# evidence (for a given PM or PRO) associated with at least one piece of content (i.e., being used/clinically referenced)
# evidence associated and documented as “built in EHR”—i.e. taken into account in EHR/point-of-care interface (linked or simply used to drive the structure/content)
# content for which there's at least one association to evidence of a particular category (ex. PM, PRO)

FIG. 18A illustrates import of evidence alignment in accordance with current practices. Flow Diagram 1800 shows a step 1802, wherein “Evidence vendor provides content title alignment mapping vendor content to customer content to provide evidence recommendations where mapping exists in a spreadsheet.”

In Step 1804, “Customer manually builds evidence into their content existing in vendor toolset to review, or in EHR after review. Process is manual.”

Vendor toolset 1810 includes Evidence 1812 that is built into a vendor content artifact 1814. Manual data mapping of vendor content title to customer content title is part of the process to create a customer content artifact 1820.

FIG. 18B illustrates import of evidence alignment in accordance with one embodiment. Flow Diagram 1850 shows a single step 1852, wherein “Evidence mapping is imported into EviCloud generating associations of evidence to content against the EHR content. Process is automated to setup review.”

Vendor toolset 1860 includes Evidence 1862 that is built into a vendor content artifact 1864. EviCloud takes the vendor data map (vendor manual effort), and EviCloud automatically constructs the evidence associations to the customer's content. This gives the customer the dynamic content management/association environment starting point.

As illustrated, EviCloud map 1880 includes a plurality of evidence 1882 and combines into a Customer Content Artifact 1884.

FIG. 19A illustrates initial and update builds of content in accordance with current practices. FIG. 19B illustrates initial and update builds of content in accordance with one embodiment.

FIG. 20 illustrates metadata use and management in accordance with one embodiment.

Accordingly, the disclosed embodiments provide numerous advantages over other methods and systems. For example, in one embodiment, the disclosed embodiments provide a method and system for gathering, maintaining, and managing clinical content from EHRs, evidence vendors, and other sources of data, which makes exploration, analysis, and processes more efficient and often automatic. EviCloud extracts and subsequently imports EHR data, EHR utilization data, clinical evidence data, and other data in order to provide an interface for designing and maintaining the structure, integrity, utility of, and relationships between, those data.

In one embodiment, the disclosed embodiments automatically build and stores important associations between those data. Those data associations drive interfaces for quickly searching, finding, filtering, and changing associations between those data, automatic change and impact analysis/insight, and interfaces for analyzing those data to provide insight into the associations and the impact of those associations on business processes, reimbursement opportunities, government and institutional incentives, and clinical outcomes related to, but not limited to, cost-saving, patient length of stay, admissions, readmissions, and mortality.

In one embodiment, EviCloud provides in and out visibility, meaning at the content's highest level, we see all data associations for any nodes within that content. However, those which are not associated to the currently selected node show semi-transparent to indicate they are associated elsewhere in that content. Implied here is a concept of selecting a node, typically in order to add/remove/modify its data associations.

In one embodiment, the disclosed embodiments eliminate the need to maintain EHR data (clinical content) in two systems. It must always be maintained in the EHR, but since EviCloud extracts the data for import it picks up any changes over time automatically. In one embodiment, EviCloud also tracks these changes on every import, enabling the ability to roll forwards/backwards in time for change impact assessments and review. In one embodiment, EviCloud enables content collaboration on the native EHR data structure.

In one embodiment, EviCloud enables much more efficient content maintenance by auto-detecting what content is impacted by changes in any associated data. This used to be a manual process for which they would pay staff or a 3rd party/consultant.

In one embodiment, EviCloud enables cost savings and time efficiency by eliminating the need to store certain data in the EHR, but instead lets customers maintain a single, static piece of data in the EHR (link) which references EviCloud as the source of truth for important data associations. In particular, an EHR build analyst no longer needs to maintain changing data associations in the EHR—the new static link never changes.

In one embodiment, EviCloud automatically computes aggregate, statistics, and assessments which previously were done manually, or were not possible—efficiency and new insight. In one embodiment, EviCloud application interfaces make it easy and efficient to make, maintain, and track data associations where previously either multiple systems had to be maintained or it was done on paper. In one embodiment, EviCloud automatically determines when associations no longer apply due to updates in imported content (versions). In one embodiment, EviCloud automatically determines what content is affected by updates to imported data to which content is associated. In one embodiment, EviCloud enables organizations to share and collaborate on clinical content.

Some disclosed embodiments provide additional technical advantages:
users do not need access to the EHR to collaborate on evidence-based content exactly as it is stored in the EHR
a complete history of changes to evidence and content is maintained outside the EHR
there is no need to maintain catalogs of procedures, medications, etc. outside the EHR
the evidence-based content management tool can also be used as a single landing page for utilization and other performance metrics
evidence vendors can associate the latest evidence directly against the EHR content in the EviCloud platform rather than performing indirect analysis via evidence vendor defined order sets etc.
healthcare providers may choose to use the EviCloud platform as a comprehensive web link management utility so as to limit building and maintenance of URLs to internal policies, procedures, and protocols in the EHR
EviCloud provides a way to search and filter EHR content quickly and efficiently in a way that may not be possible inside the EHR
comments placed in the collaboration area of EviCloud can be used to generate specifications for build of EHR content

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

One skilled in the art will appreciate that variations of the above-disclosed and other features and functions, or alternatives thereof, may be desirably combined into many other different systems or applications. Additionally, various presently unforeseen or unanticipated alternatives, modifications, variations or improvements therein may be subsequently made by those skilled in the art, which are also intended to be encompassed by the following claims.

What is claimed is:

1. A user interface for presenting associated data to a user, the user interface comprising:
a user input device configured to receive user input;
a display having a screen configured to present an information framework to a user;
wherein the information framework comprises a first area and a second area;
wherein each of the first and second areas present a view associated with a collection of data;
wherein the first and second areas do not overlap with each other;
wherein the data comprises content, evidence, and associations linking evidence and content;
wherein the content comprises a plurality of operational material items and the evidence comprises a plurality of support material items;
wherein the first area is configured to present options for selection by a user and an input box to receive a search query from the user;
wherein the search query and user-selected option together comprise a user request;
wherein the information framework couples to a server, the server being configured to process user requests;
wherein the second area is configured to receive server responses to the user requests and to display received server responses to the user in at least the second area;
wherein the server response comprises indicia uniquely identifying an item of operational material or an item of evidence, and indicia identifying an association between the uniquely identified item and at least one other item of operational material or item of evidence; and
wherein the second area is configured to display the uniquely identified item and at least one other item of operational material or item of evidence associated with the uniquely identified item.

2. The user interface of claim 1, wherein the collection data is electronic health record data.

3. The user interface of claim 1, further comprising:
wherein options presented for selection by a user of the first area include at least one item of supplemental data;
wherein the server response includes an identified content item, the identified content item being selected by the server based on the received item of supplemental data;
wherein the first area is configured to display the identified content item;
wherein the server response further includes an evidence association, the evidence association comprising at least one item of evidence associated with the identified content item;
wherein the second area is configured to display the at least one item of evidence associated with the identified order set; and
wherein the second area is further configured to display supplemental data associated with the at least one item of evidence associated with the identified order set.

4. The user interface of claim 2, further comprising:
wherein the content includes at least one clinical content record or artifact;
wherein the input box of the first area is configured to receive a title search string representing a desired clinical content record or artifact;
wherein the server response includes an identified clinical content record or artifact, the identified clinical content record or artifact being selected by the server based on the received title search string;
wherein the first area is configured to display the identified clinical content record or artifact and associated utilization data;
wherein the server response further includes an evidence association, the evidence association comprising at least one item of evidence associated with the identified clinical content record or artifact;
wherein the second area is configured to display the at least one item of evidence associated with the identified clinical content record or artifact;
wherein the second area is further configured to display supplemental data associated with the at least one item of evidence associated with the identified clinical content record or artifact.

5. The user interface of claim 1, wherein the views presented in the first and second areas are different.

6. The user interface of claim 1, wherein the first and second areas are one of horizontal bands and quadrants.

7. A method for maintaining an electronic health records (EHR) information system, comprising:
extracting EHR data from an operational EHR system, the operational EHR system having a structure and a plurality of associations;
wherein the extracting EHR data preserves the structure and plurality of associations;
converting extracted EHR data to a first intermediate format;
importing converted EHR data into a first custom database; and
displaying, to a user, information stored in the EHR data based on at least the structure and plurality of associations.

8. The method of claim 7, further comprising:
detecting a change in the structure or one of the plurality of associations in the EHR data based on a previously saved version of the imported EHR data; and
displaying the difference between the current version and the saved version to a user.

9. The method of claim 7, further comprising:
extracting evidence data from a vendor-source;
converting extracted evidence to a second intermediate format;
importing the Intermediate format evidence data into a second custom database; and
associating imported EHR data with imported evidence data.

10. The method of claim 7, wherein extracting EHR data further comprises preserving the structure and plurality of associations at all levels of granularity.

11. The method of claim 7, further comprising receiving revised evidence data from a vendor source; and
automatically revising the associations of the imported EHR with imported evidence data.

12. A method for maintaining a system of complex information, comprising:
extracting, from an existing system of complex information, a structure and a plurality of associations;
wherein the extracting preserves the structure and plurality of associations;
converting extracted data to a first intermediate format;
importing converted data into a first custom database; and
displaying, to a user, information stored in the existing system of complex information data based on at least the structure and plurality of associations.
